(19) United States
(12) Patent Application Publication
(10) Pub. No.: US 2019/0013926 A1
(43) Pub. Date: Jan. 10, 2019

(54) TIME SYNCHRONOUS SLAVE DEVICE AND COMMUNICATION CONTROL METHOD

(71) Applicant: Mitsubishi Electric Corporation, Tokyo (JP)

(72) Inventor: Taichi SAKAUE, Tokyo (JP)

(73) Assignee: Mitsubishi Electric Corporation, Tokyo (JP)

(21) Appl. No.: 16/067,781

(22) PCT Filed: Feb. 24, 2016
(86) PCT No.: PCT/JP2016/055462

§ 371 Date: Jul. 2, 2018

(51) Int. Cl. H04L 7/00

(52) U.S. Cl. CPC H04L 7/0008

(57) ABSTRACT

A token management slave device is included in a communication system. The communication system includes a master device, time asynchronous slave devices communicating with the master device and not being time synchronized with the master device, and time synchronous slave devices communicating with the master device and being time synchronized with the master device. The token management slave device sets an asynchronous communication period in which the master device and the time asynchronous slave devices communicate, between a plurality of synchronous communication periods that is a plurality of periods in which the master device and the time synchronous slave devices communicate. Then, the token management slave device instructs the time asynchronous slave devices to communicate with the master device, when the asynchronous communication period arrives.

### TECHNICAL FIELD

The present invention relates to a communication system having a master-slave configuration.

### BACKGROUND ART

In an FA (Factory Automation) system, a control system is often configured with one master device and a plurality of slave devices. Generally, the master device and the slave devices communicate via a control network for FA, the master device gives instructions to the slave devices, and the slave devices transmit response results to the instructions to the master device.

A time period until when one round for the instructions and the responses between the master device and the slave devices completes is referred to as a communication cycle.

In the control network used in the FA system, the communication cycle is preset and control communication needs to be completed within this communication cycle.

In a recent FA system, slave devices (referred to below as time synchronous slave devices) being time synchronized with the master device are used. In an FA system in which the time synchronous slave devices are used, transmission is triggered at predetermined time in time synchronous slave devices and the time synchronous slave devices transmit communication frames to the master device.

In contrast, in a conventional FA system, slave devices (referred to below as time asynchronous slave devices) not being time synchronized with the master device are used. In an FA system in which time asynchronous slave devices are used, a token passing method or the like is used in which the master device manages a transmission right of time asynchronous slave devices and circulates the transmission right among the time asynchronous slave devices in a certain cycle.

Communication between the master device and time synchronous slave devices is referred to below as time synchronous communication and communication between the master device and time asynchronous slave devices is referred to as time asynchronous communication.

Patent Literature 1 discloses a method for switching the communication time periods between a master device and slave devices in a time division manner in a case where time synchronous slave devices and time asynchronous slave devices coexist in one network. That is, this communication method switches between a time slot for the time synchronous communication and a time slot for the time asynchronous communication with the master device in the time division manner. In the time slot for the time asynchronous communication, token passing is performed between the master device and a plurality of time asynchronous slave devices.

### CITATION LIST

### Patent Literature

Patent Literature 1: WO2013-077148

### SUMMARY OF INVENTION

### Technical Problem

In the method of Patent Literature 1, the time asynchronous communication cannot be started until communication between the master device and all time synchronous slave devices is completed. In addition, the time synchronous communication cannot be started until the token is returned to the master device, when the time asynchronous communication is performed. Accordingly, there is a problem that a real time property cannot be ensured in the time synchronous communication and the time asynchronous communication.

The present invention mainly aims to solve the above problem. The present invention maily aims to ensure the real time property in the time synchronous communication and the time asynchronous communication.

### Solution to Problem

A time synchronous slave device according to the present invention included in a communication system including a master device and a time asynchronous slave device communicating with the master device and not being time synchronized with the master device, communicating with the master device and being time synchronized with the master device, includes:

a setting unit to set an asynchronous communication period in which the maser device and the time asynchronous slave device communicate, between a plurality of synchronous communication periods that is a plurality of periods in which the master device and the time synchronous slave device communicate; and

a communication instructing unit to instruct the time asynchronous slave device to communicate with the master device, when the asynchronous communication period arrives.

### Advantageous Effects of Invention

In the present invention, an asynchronous communication period is set between synchronous communication periods and a time asynchronous slave device is instructed to communicate with a master device when the asynchronous communication period arrives. Therefore, according to the present invention, it is possible to ensure a real time property in the time synchronous communication and the time asynchronous communication.

### BRIEF DESCRIPTION OF DRAWINGS

FIG. 1 is a diagram illustrating an example of a configuration of a communication system according to a first embodiment;

FIG. 2 is a diagram illustrating an example of a hardware configuration of a master device and a slave device according to the first embodiment;

FIG. 3 is a diagram illustrating an example of a functional configuration of a communication device of the master device according to the first embodiment;

FIG. 4 is a diagram illustrating an example of a functional configuration of a communication device of the slave device according to the first embodiment;

FIG. 5 is a flowchart schematically illustrating operation of the master device and the slave device according to the first embodiment;

FIG. 6 is a flowchart illustrating an example of operation in an initial setting phase according to the first embodiment;

FIG. 7 is a flowchart illustrating an example of operation in the initial setting phase according to the first embodiment;

FIG. 8 is a flowchart illustrating an example of operation of a token management slave device in a fixed cycle communication phase according to the first embodiment;

FIG. 9 is a diagram illustrating an example of an available band according to the first embodiment;

FIG. 10 is a diagram illustrating communication sequences of time synchronous communication and time asynchronous communication according to the first embodiment;

FIG. 11 is a diagram illustrating an example of a configuration of a communication system according to a second embodiment;

FIG. 12 is a diagram illustrating an example of available bands according to the second embodiment; and

FIG. 13 is a flowchart illustrating an example of operation in an initial setting phase according to the second embodiment.

### DESCRIPTION OF EMBODIMENTS

### First Embodiment

### ***Description of Configuration***

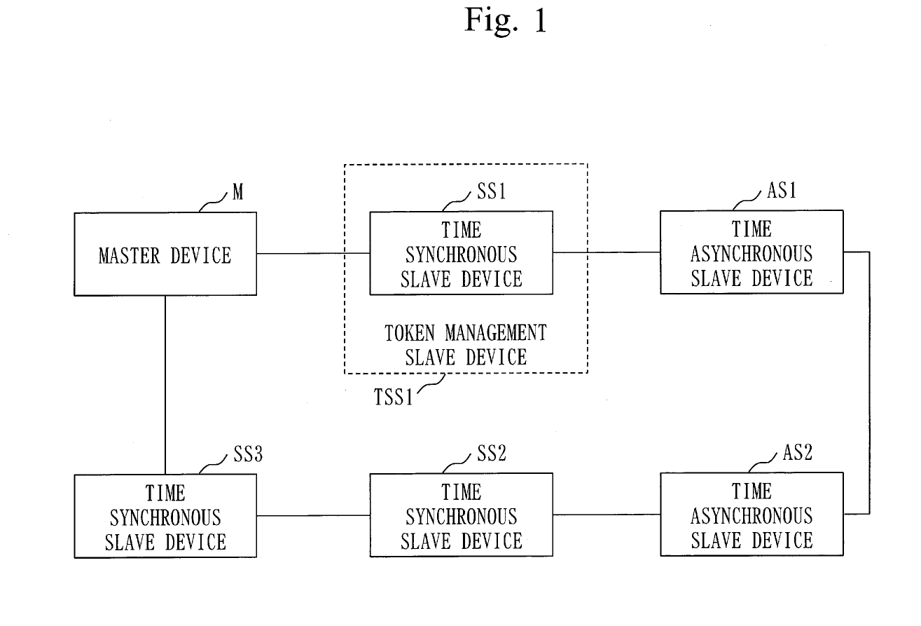

FIG. 1 illustrates an example of a configuration of a communication system according to the present embodiment.

As illustrated in FIG. 1, in the communication system according to the present embodiment, a master device, time synchronous slave devices and time asynchronous slave devices exist.

Specifically, a master device M, time synchronous slave devices SS1, SS2, and SS3, and time asynchronous slave devices AS1 and AS2 are connected to a network.

When it is not necessary to distinguish the time synchronous slave devices SS1, SS2, and SS3 from each other, the time synchronous slave devices SS1, SS2, and SS3 are collectively referred to as a time synchronous slave device SS.

When it is not necessary to distinguish the time asynchronous slave devices AS1 and AS2 from each other, the time asynchronous slave devices AS1 and AS2 are collectively referred to as a time asynchronous slave device AS.

The time synchronous slave device SS is a slave device that communicates with the master device M and is time synchronized with the master device M. The time synchronous slave device SS communicates with the master device M without performing token passing.

The time asynchronous slave device AS is a slave device that communicates with the master device M and is not time synchronized with the master device M. The time asynchronous slave device AS communicates with the master device M when receiving a token by token passing.

The time synchronous slave device SS and the time asynchronous slave device AS are collectively referred to below as a slave device S.

In the present embodiment, the time synchronous slave device SS1 is selected as a token management slave device. The token management slave device sets a period in which the master device M and the time asynchronous slave devices AS asynchronously communicate, and controls token passing among the time asynchronous slave devices AS. In the following, the time synchronous slave device SS1 is also referred to as a token management slave device TSS1. Operation by the time synchronous slave device SS1 corresponds to an example of a communication control method.

In addition, the master device M may be simply referred to below as a master. In addition, the time synchronous slave device SS may be simply referred to below as a time synchronous slave. Further, the time asynchronous slave device AS may be simply referred to below as a time asynchronous slave. Furthermore, the token management slave device TSS1 may be simply referred to below as a token management slave.

Although FIG. 1 illustrates a ring type network, the network topology is not limited to a ring type and may be, for example, a star type network via a switching hub.

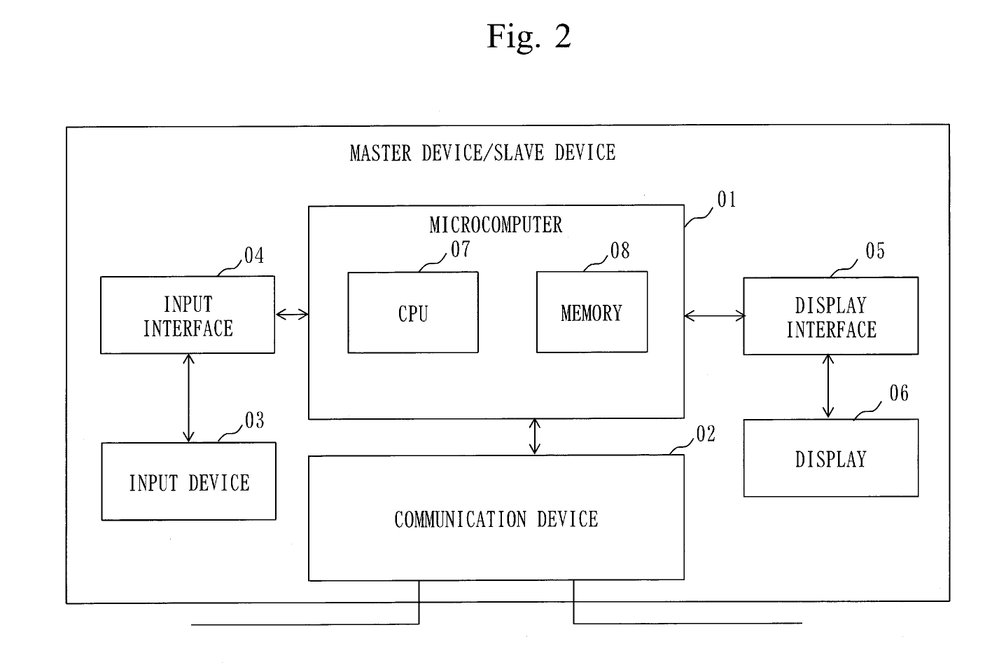

FIG. 2 illustrates an example of a hardware configuration of the master device M and the slave device S according to the present embodiment.

In the present embodiment, the master device M and the slave device S have the hardware configuration of FIG. 2 in common.

The master device M and the slave device S each are configured with a microcomputer 01, a communication device 02, an input device 03, an input interface 04, a display interface 05 and a display 06. The microcomputer 01 includes a CPU 07 and a memory 08.

Since the microcomputer 01, the input device 03, the input interface 04, the display interface 05 and the display 06 are the same as those included in an existing master device and slave device, descriptions are omitted and only a functional configuration of the communication device 02 will be described.

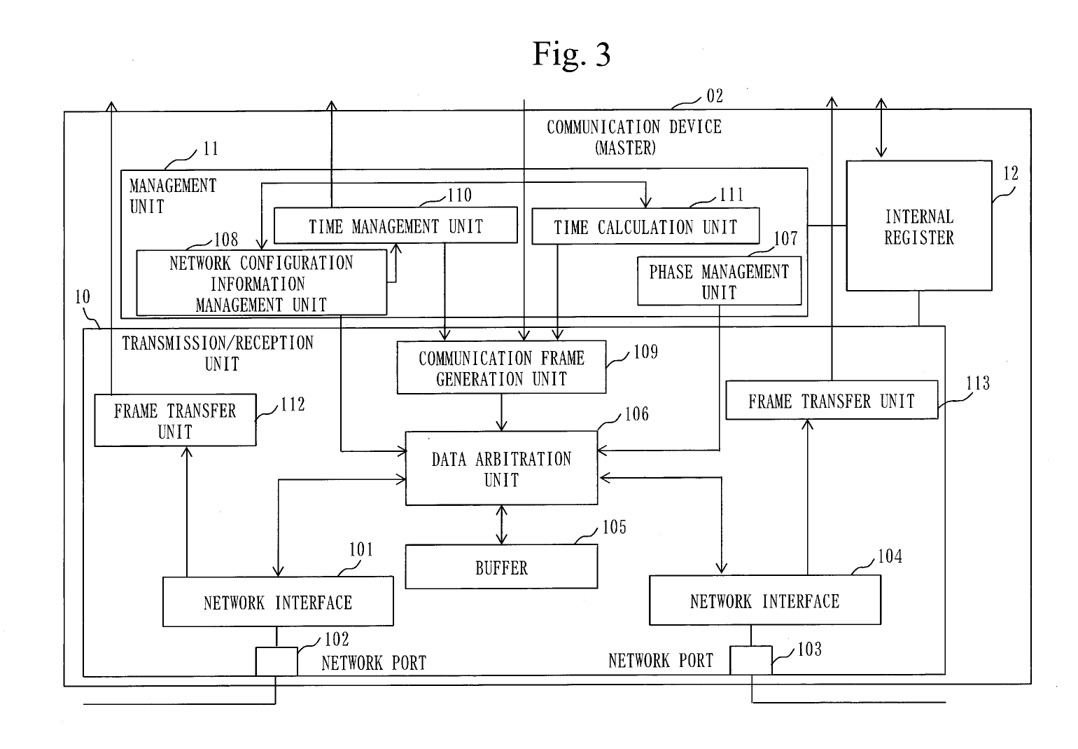

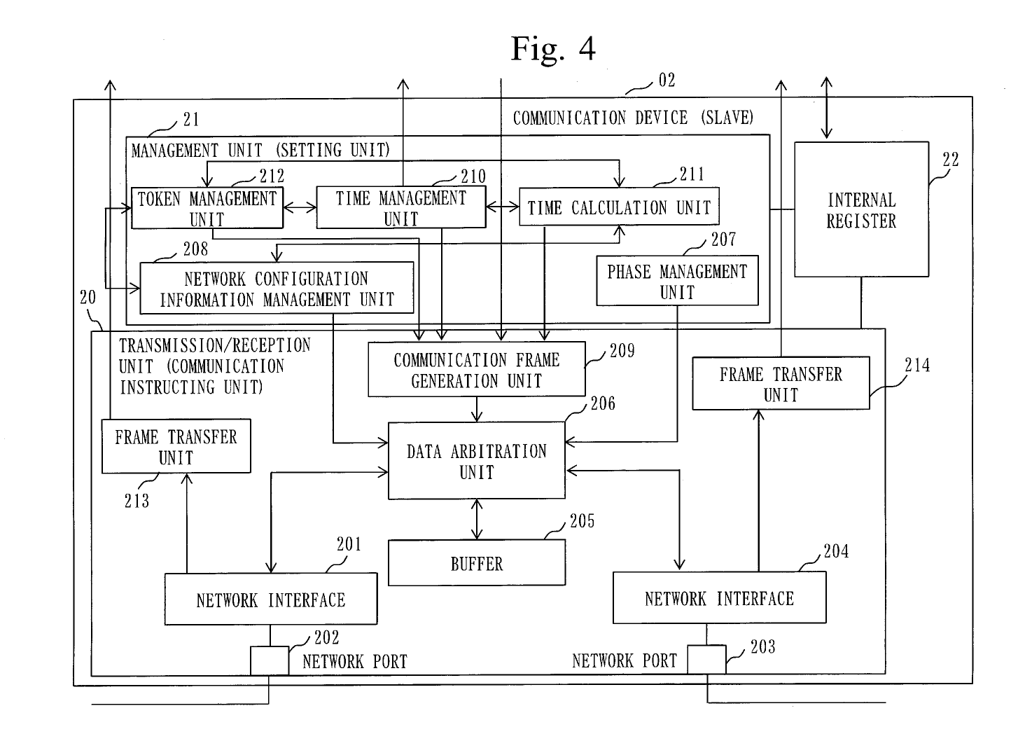

FIG. 3 illustrates an example of the functional configuration of the communication device 02 of the master device M and FIG. 4 illustrates an example of the functional configuration of the communication device 02 of the slave device S.

As illustrated in FIG. 3, the communication device 02 of the master device M is configured with a transmission/reception unit 10, a management unit 11, and an internal register 12.

In addition, as illustrated in FIG. 4, the communication device 02 of the slave devices S is configured with a transmission/reception unit 20, a management unit 21, and an internal register 22.

The functional configuration illustrated in FIG. 3 is implemented as hardware. Specifically, the transmission/reception unit 10, the management unit 11, and the internal register 12 are realized by circuits.

In addition, the functional configuration illustrated in FIG. 4 is implemented as hardware. Specifically, the transmission/reception unit 20, the management unit 21, and the internal register 22 are realized by circuits

A circuit is a concept including a processing circuit such as a logic IC (Integrated Circuit), a gate array, an ASIC (Application Specific Integrated Circuit), or an FPGA (Field-Programmable Gate Array).

In FIG. 3, network interfaces 101 and 104 perform an error check of communication frames (referred to below as received frames) received from network ports 102 and 103 using FCS (Frame Check Sequence), and add FCS to communication frames when transmitting the communication frames. In addition, the network interfaces 101 and 104 determine the destination of a received frame and, when the received frame is addressed to the device itself, transfer the received frame to a frame transfer unit 112 or a frame transfer unit 113. In contrast, when the received frame is addressed to another device, the network interfaces 101 and 104 transfer the received frame to a data arbitration unit 106 so as to relay the received frame.

The network ports 102 and 103 are physical interfaces (connectors) with a network.

A buffer 105 retains the frame of which transmission will be awaited in a case where a transmission conflict occurs in the data arbitration unit 106 between a relay frame received by the network port 102 or 103 and a communication frame generated by a communication frame generation unit 109.

The data arbitration unit 106 performs transmission arbitration between the relay frame received by the network port 102 and 103 and the communication frame generated by the communication frame generation unit 109.

A phase management unit 107 is a state machine that manages communication phases.

The communication phases according to the present embodiment include an initial setting phase and a fixed cycle communication phase.

A network configuration information management unit 108 reads, from the internal register 12, the number of the slave devices S connected to the master device M, the stream size and the number of streams transmitted by the slave devices S, and the reception time limits of frames by the slave devices. In addition, the network configuration information management unit 108 generates communication frames for setting the slave devices S in the initial setting phase. A stream is a set of frames transmitted by one master device M or one slave device S in one cycle. A token frame of asynchronous communication is also included in the stream.

The communication frame generation unit 109 generates a communication frame based on the information of fixed cycle communication output from the microcomputer 01.

A time management unit 110 counts the current time. In addition, the time management unit 110 causes the microcomputer 01 to start transmission of a communication frame at a set cycle.

A time calculation unit 111 calculates a reception time limit of communication frames transmitted from the slave devices S based on the communication cycle, the network configuration information, the frame size, and the number of frames.

The frame transfer units 112 and 113 transfer to the microcomputer 01, received communication frames addressed to the device itself.

In FIG. 4, as with the network interfaces 101 and 104 of the master device M, network interfaces 201 and 204 perform an error check of communication frames (referred to below as received frames) received from network ports 202 and 203 using FCS, and add FCS to communication frames when transmitting the communication frames. In addition, the network interfaces 201 and 204 determine the destination of a received frame and, when the received frame is addressed to the device itself, transfer the received frame to a frame transfer unit 213 or a frame transfer unit 214. In contrast, when the received frame is addressed to another device, the network interfaces 201 and 204 transfer the received frame to a data arbitration unit 206 so as to relay the received frame.

The network ports 202 and 203 are physical interfaces (connectors) with a network, as with the network ports 102 and 103 of the master device M.

As with the buffer 105 of the master device M, a buffer 205 retains the frame of which transmission will be awaited in a case where a transmission conflict occurs in the data arbitration unit 206 between a relay frame received by the network port 202 or 203 and a communication frame generated by a communication frame generation unit 209.

As with the data arbitration unit 106 of the master device M, the data arbitration unit 206 performs transmission arbitration between the relay frame received by the network ports 202 and 203 and the communication frame generated by the communication frame generation unit 209.

As with the phase management unit 107 of the master device M, a phase management unit 207 is a state machine that manages the communication phases (initial setting phase and fixed cycle communication phase).

When the device itself (slave device S) is a token management slave device, a network configuration information management unit 208 recognizes the number of the time asynchronous slave devices AS managed by the device itself.

As with the communication frame generation unit 109 of the master device M, the communication frame generation unit 209 generates a communication frame based on the information of fixed cycle communication output from the microcomputer 01. In addition, the communication frame generation unit 209 generates a token frame.

As with the time management unit 110 of the master device M, a time management unit 210 counts the current time. In addition, the time management unit 210 causes the microcomputer 01 to start transmission of a communication frame at a set cycle.

In addition, the time management unit 210 extracts a time period for which no communication is performed in the network as an available band and outputs a transmission trigger to a token management unit 212, in a case where the device itself (slave device S) is a token management slave device.

In addition, the time management unit 210 specifies the number of time asynchronous slave devices AS to which a token can be passed within the extracted available band (time asynchronous communication band) and reports the specified number of time asynchronous slave devices AS to the token management unit 212, in a case where the device itself (slave device S) is a token management slave device.

A time calculation unit 211 calculates a transmission time of the communication frame of the device itself based on the frame reception time limits of the slave devices S reported by the master device M.

The token management unit 212 selects a token route based on the number of the time asynchronous slave devices AS to which the token can be passed within the extracted available band (the time asynchronous communication band) reported by the time management unit 210.

In addition, the token management unit 212 manages (stores) information of the selected token route. Further, the token management unit 212 outputs the information of the token route to the communication frame generation unit 209 according to the transmission trigger from the time management unit 210.

As with the frame transfer units 112 and 113 of the master device M, the frame transfer units 213 and 214 transfer the received communication frames addressed to the device itself to the microcomputer 01.

If the slave device S is the token management slave device, the management unit 21 functions as a setting unit.

That is, the management unit 21 of the token management slave device TSS1 sets a time asynchronous communication band (the time asynchronous communication band corresponds to an asynchronous communication period) that is a period in which the master device M and the time asynchronous slave devices AS1 and AS2 perform communication, between a plurality of time synchronous communication bands (a time synchronous communication band corresponds to a synchronous communication period) that are a plurality of periods in which the master device M and the time synchronous slave devices SS1, SS2, and SS3 perform time synchronous communication. More specifically, the management unit 21 of the token management slave device TSS1 monitors communication between the master device M and the time synchronous slave device SS1 (token management slave device TSS1). Then, the management unit 21 of the token management slave device TSS1 extracts a period in which communication is performed between the master device M and the time synchronous slave device SS1 (the token management slave device TSS1) as the time synchronous communication band and sets the time synchronous communication band between extracted time synchronous communication bands.

In addition, the management unit 21 of the token management slave device TSS1 sets a plurality of time asynchronous communication bands and determines, for each of the time asynchronous communication bands, whether the token can be passed to all of the time asynchronous slave devices AS1 and AS2 and all of the time asynchronous slave devices AS1 and AS2 can complete communication with the master device M within the time asynchronous communication band. Specifically, the management unit 21 of the token management slave device TSS1 measures a time period required for all of the time asynchronous slave devices AS1 and AS2 to complete communication with the master device M and determines whether all of the time asynchronous slave devices AS1 and AS2 can complete communication with the master device M for each of the time asynchronous communication bands.

When all of the time asynchronous slave devices AS1 and AS2 cannot complete communication with the master device M in each of the time asynchronous communication bands, the management unit 21 of the token management slave device TSS1 selects the time asynchronous slave device AS that communicates with the master device M from among the time asynchronous slave devices AS1 and AS2 for each of the asynchronous communication periods based on the order of token passing.

If the slave device S is the token management slave device TSS1, the transmission/reception unit 20 functions as a communication instructing unit.

That is, when the time asynchronous communication band arrives, the transmission/reception unit 20 of the token management slave device TSS1 instructs the time asynchronous slave devices AS1 and AS2 to communicate with the master device M, by transmitting a token frame.

***Description of Operation***

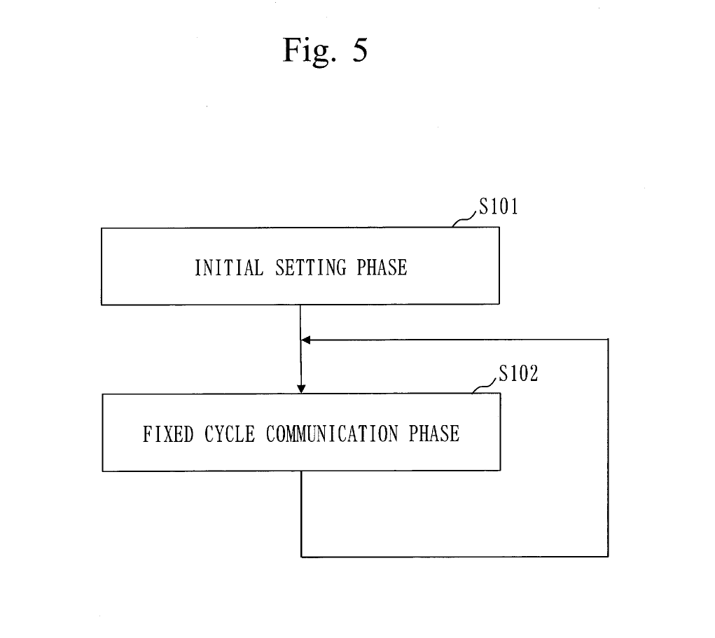

FIG. 5 schematically illustrates operation performed by the master device M and the slave devices S.

The master device M and the slave devices S first perform processing in the initial setting phase (step S101). In the initial setting phase, time synchronous communication bands are set between the master device M and the time synchronous slave devices SS. In addition, the token management slave device TSS1 sets a time asynchronous communication band between the time synchronous communication bands.

Next, the master device M and the slave devices S perform processing in the fixed cycle communication phase (step S102). In the fixed cycle communication phase, time synchronous communication is performed between the master device M and the time synchronous slave devices SS in the time synchronous communication band. In addition, the time asynchronous communication is performed between the master device M and the time asynchronous slave devices AS in the time asynchronous communication band. In the fixed cycle communication phase, the time synchronous communication band and the time asynchronous communication band arrive alternately. In principle, the fixed cycle communication phase is repeated until the system stops.

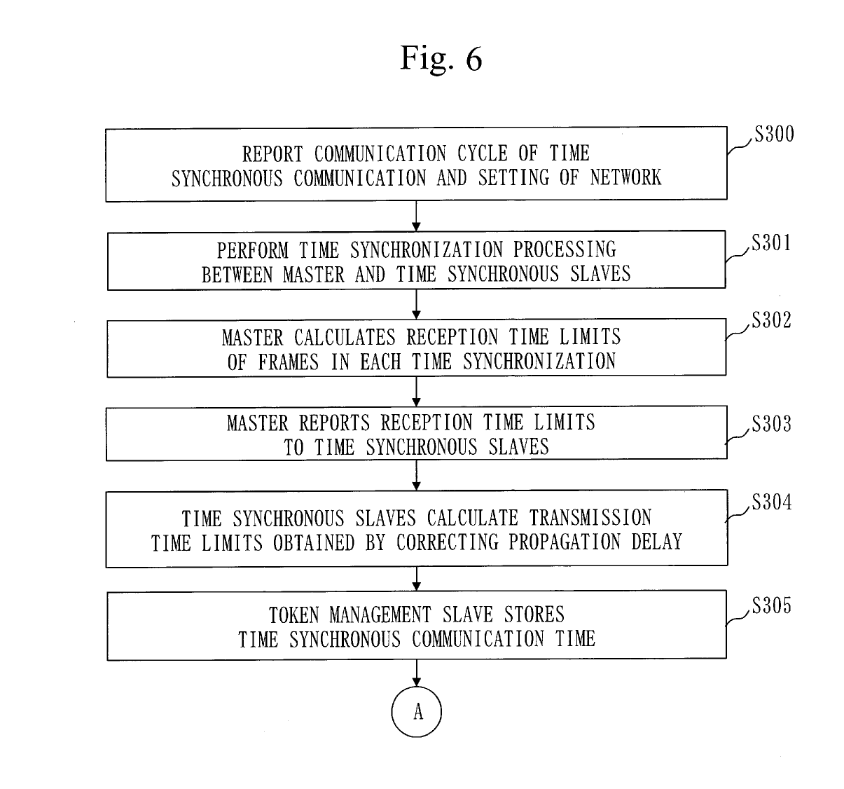

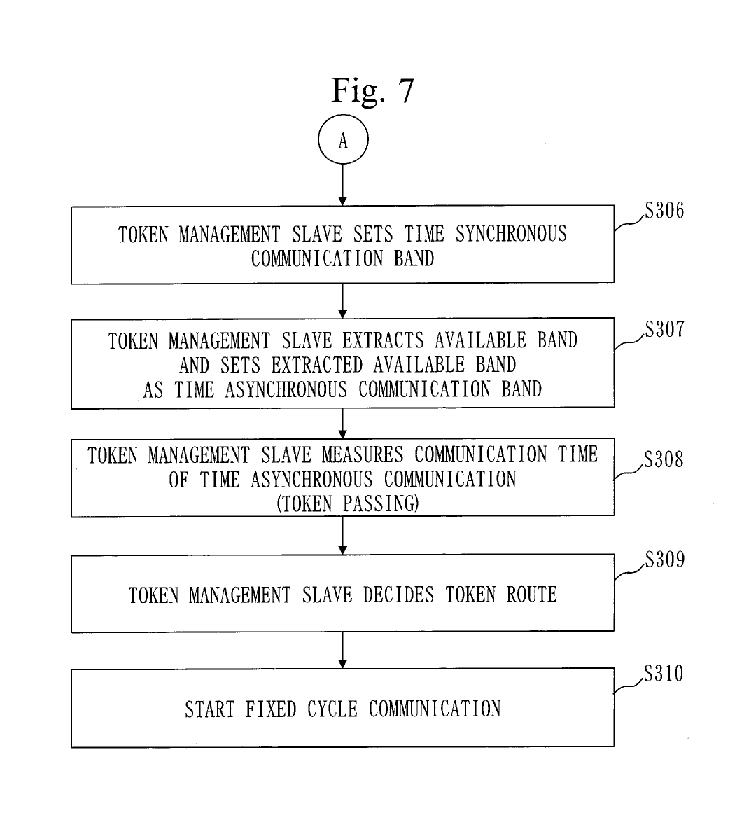

Next, the operation in the initial setting phase will be described with reference to FIG. 6 and FIG. 7.

First, in step S300, the network configuration information management unit 108 of the master device M obtains network configuration information from the slave devices S and reports the settings of the slave devices S and a communication cycle T_a of the time synchronous communication preset by the user to the time calculation unit 111.

Next, in step S301, the master device M and the time synchronous slave devices SS1, SS2, and SS3 perform time synchronization. The time synchronization is performed by the method described in the following reference document. Reference document: IEEE Std 1588-2008

Next, in step S302, the time calculation unit 111 of the master device M calculates time required for time synchronous communication based on the frame size and the number of frames of time synchronous communication stored in the network configuration information management unit 108. The frame size and the number of frames of time synchronous communication are fixed values. Then, the time calculation unit 111 of the master device M calculates the reception time limits of frames in the master device M from the time synchronous slave devices SS using expression (3) below.

The set of frames transmitted by one device for one cycle is referred to as a stream, as described above. A stream size S_n of a time synchronous slave device n is calculated by expression (1) below. The time synchronous slave device n represents the n-th time synchronous slave device SS.

[Formula 1]

S_n=Σᵢ₌₀^{M-1}Fₙ_{_}i+L_{IFG}·(M−1) (1)

In the above description, Fn_i represents the frame size of the i-th frame of the time synchronous slave device n. L_{IFG} represents the inter-frame gap length. M represents the number of frames transmitted by one device.

In addition, a time synchronous communication band T_n of the time synchronous slave n is calculated by the following.

T_n=communication cycle T_a×(stream size S_n of time synchronous slave device n/sum of stream sizes of all time synchronous slaves)

That is, T_n can be expressed by expression (2) below.

[Formula 2]

T_n=T_a×S_n/Σₙ₌₀^{N}^{_}^{h-1}S_n (2)

The reception time limit in the master of the frame of the time synchronous slave device n can be expressed by expression (3) below. T_k indicates the band of the k-th time synchronous slave device SS.

[Formula 3]

t_lim_n=Σₖ₌₀ⁿT_k (3)

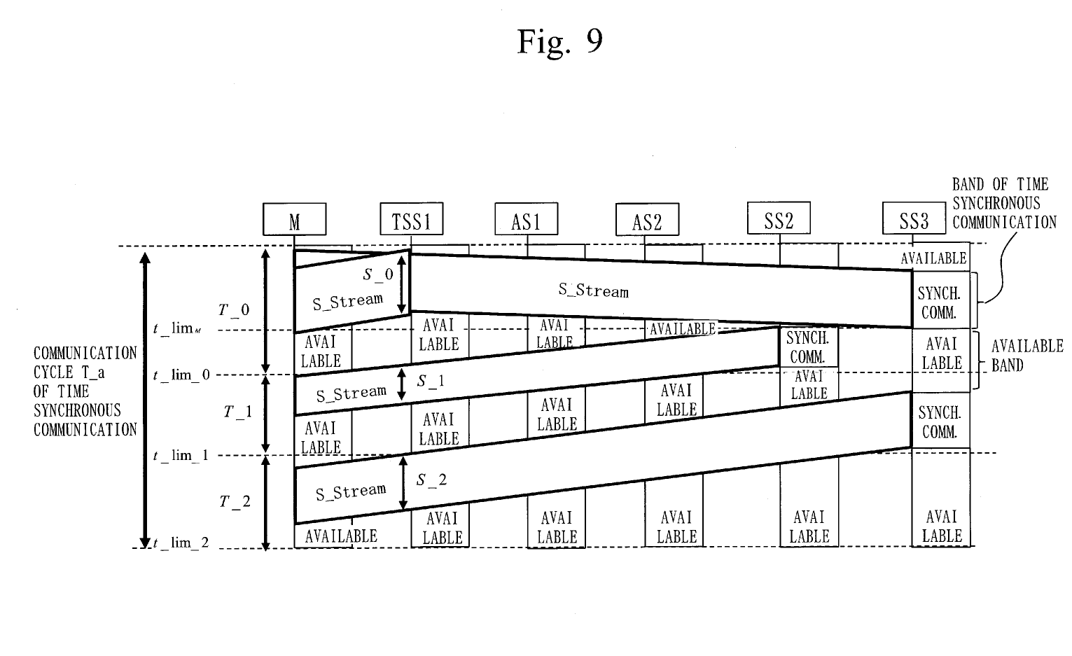

FIG. 9 illustrates the communication cycle T_a, the time synchronous communication bands T_n, and reception time limits t_lim_n of time synchronous communication. In FIG. 9, the vertical axis represents time.

As described above, T_a is the communication cycle of time synchronous communication. T_0, T_1, and T_2 are the time periods (time slot lengths) assigned to the frame transmission of the token management slave device TSS1 and the time synchronous slave devices SS2 and SS3 in the communication cycle. T_lim_0, t_lim_1, and t_lim_2 are the reception time limits in the master device M of the streams transmitted by the token management slave device TSS1 and the time synchronous slave devices SS2 and SS3.

The times indicated by “AVAILABLE” are available bands where no communication is performed by any of time synchronous slave devices. As described later, the token management slave device TSS1 performs token passing in available bands and causes the time asynchronous slave devices AS1 and AS2 to perform time asynchronous communication.

In step S303, the communication frame generation unit 109 of the master device M generates a frame for reporting the reception time limit t_lim_n of a frame to be transmitted by the time synchronous slave device n and the network ports 102 and 103 transmit the frame to the time synchronous slave devices.

In step S304, the time calculation unit 211 of each of the time synchronous slave devices SS calculates a transmission start time t_txlim_n of the device itself based on the reception time limit reported by the master device M.

The time calculation unit 211 calculates the transmission start time t_txlim_n of the device itself according to expression (4) below. T_{delay}_{_}n is a propagation delay to the time synchronous slave device n obtained by correcting a propagation delay from the master device M. T_s represents the transmission speed.

[Formula 4]

t_txlim_n=lim_n−S_n/T_s−t_{delay}_{_}n (4)

Next, in step S305, the time calculation unit 211 of each of the time synchronous slave devices SS reports the calculated transmission start time to the time management unit 210 of the token management slave device TSS1 and the time management unit 210 stores the reported transmission start time. In addition, each of the time synchronous slave devices SS reports the transmission start time of the device itself to the master device M.

Next, in step S306, the time management unit 210 of the token management slave device TSS1 sets the time synchronous communication band. That is, the time management unit 210 of the token management slave device TSS1 sets the time synchronous communication band based on the stream size, the number of streams, and the transmission start time of the communication frame of each of the time synchronous slave devices SS1, SS2, and SS3.

The master device M reports the stream size, the number of streams, and the transmission start time of the communication frame of each of the time synchronous slave devices SS1, SS2, and SS3 to the token management slave device TSS1.

The token management slave device TSS1 sets a time period from (t_txlim_n) to (t_txlim_n+S_n/Ts) as a band of time synchronous communication within one communication cycle, according to expression (1) and expression (4) using the information reported from the master device M.

Next, in step S307, the time management unit 210 of the token management slave device TSS1 extracts an available band of the token management slave device TSS1 in one communication cycle. First, the time management unit 210 performs the time synchronous communication for one cycle with the master device M and all time synchronous slave devices SS connected to the network. The time synchronous communication is started when the master device M transmits a frame for reporting the start of communication. Each of the synchronous slave devices SS having received this frame from the master device M recognizes that the start of time synchronous communication and transmits a frame of the device itself at the transmission start time calculated in S304.

At this time, the time calculation unit 211 of the token management slave device TSS1 records the time in which the band of the device itself is available in one communication cycle.

The data arbitration unit 206 of the token management slave device TSS1 asserts a line usage flag while transmitting the communication frame from the device itself or relaying the communication frame. In addition, the time calculation unit 211 of the token management slave device TSS1 records a time period for which the line usage flag is negated.

In addition, the time calculation unit 211 of the token management slave device TSS1 reports a time period in which a band becomes available, that is, a time period for which the line usage flag is negated to the time management unit 210 after the communication cycle start time. The time management unit 210 stores this result.

Then, the time management unit 210 of the token management slave device TSS1 sets, as the time asynchronous communication band, the time period in which the band becomes available reported from the time calculation unit 211. That is, the time management unit 210 of the token management slave device TSS1 sets the time period between the time synchronous communication bands as the time asynchronous communication band. Since the intervals between the time synchronous communication bands are equal in the present embodiment, the time asynchronous communication band is a fixed value.

Next, in step S308, the time calculation unit 211 of the token management slave device TSS1 measures the communication time period of asynchronous communication (token passing). The time calculation unit 211 of the token management slave device TSS1 measures the time period from when the token frames are transmitted from the token management slave device TSS1 to when the token frames are received from the time asynchronous slave devices AS. Since the token frames are multicasted, the time calculation unit 211 of the token management slave device TSS1 can measure the time period until a token frame is received from the time asynchronous slave device AS, for each of the time asynchronous slave devices AS.

Next, in step S309, the token management unit 212 of the token management slave device TSS1 determines a token route within the time asynchronous communication band. The token route is the combination and order of time asynchronous slave devices AS through which a token can be circulated in the time asynchronous communication band. The time management unit 210 of the token management slave device TSS1 specifies the number of the time asynchronous slave devices AS to which the token can be passed within the time asynchronous communication band, based on the time period measured in step S308. In addition, the time management unit 210 reports the specified number of the time asynchronous slave devices AS to the token management unit 212. The token management unit 212 has the network configuration information management unit 208 store the number of the time asynchronous slave devices AS reported from the time management unit 210.

The token management unit 212 determines whether the token can be passed to all of the time asynchronous slave devices AS within the time asynchronous communication band. When the token can be passed to all of the time asynchronous slave devices AS within the time asynchronous communication band, the token management unit 212 adopts, as the token route, the route with which the token can be passed to all of the time asynchronous slave devices AS in each of the time asynchronous communication bands. In contrast, when the token cannot be passed to all of the time asynchronous slave devices AS within the time asynchronous communication band, the token management unit 212 selects the time asynchronous slave devices AS (time asynchronous slave devices AS that communicate with the master device M) among which the token is circulated, for each of the time asynchronous communication bands.

Specifically, the token management unit 212 selects the time asynchronous slave devices AS among which the token is circulated for each of the time asynchronous communication bands according to the order of token passing within the number of the time asynchronous slave devices AS to which the token can be passed within the time asynchronous communication band. The route configured with the time asynchronous slave devices AS selected for each of the time asynchronous communication bands is adopted as the token route for each of the time asynchronous communication bands. The information of the adopted token routes is stored in the token management unit 212 of the token management slave device TSS1.

The information of the token route stored in the token management unit 212 includes the combination and order of the time asynchronous slave devices AS among which the token is circulated.

For example, in a case where the token can be circulated among both the time asynchronous slave devices AS1 and AS2 in one time asynchronous communication band, the token management unit 212 decides a token route including both the time asynchronous slave devices AS1 and AS2 as the token route for each of the time asynchronous communication bands.

In contrast, in a case where the token cannot be circulated among both the time asynchronous slave devices AS1 and AS2 in one time asynchronous communication band, the token management unit 212 decides a token route including only the time asynchronous slave device AS1 as the token route for the initial time asynchronous communication band and decides a token route including only the time asynchronous slave device AS2 as the token route for the next time asynchronous communication band.

The token management unit 212 of the token management slave device TSS1 can change the token route of a particular time asynchronous communication band.

As described above, the initial setting phase is completed and the fixed cycle communication phase is started (step S310).

More specifically, when determining the token route, the token management slave device TSS1 reports to the master device M that the token route has been decided and the master device M transmits a notification for starting the fixed cycle communication to the slave devices S.

Then, the phase management unit 107 of the master device M makes a state transition to the fixed cycle communication phase. In each of the slave devices S, when receiving the notification for starting the fixed cycle communication, the phase management unit 207 makes a state transition to the fixed cycle communication phase.

In the time synchronous slave devices SS1, SS2, and SS3, when recognizing the start time of the fixed cycle communication, the time management unit 210 starts a timer for counting one communication cycle and the timer starts counting up.

In the time synchronous slave devices SS1, SS2, and SS3, when the timer reaches the transmission start time calculated in step S304, the time management unit 210 instructs the communication frame generation unit 209 to generate a communication frame. The communication frame generation unit 209 generates a communication frame for time synchronous communication. The generated communication frame is transmitted to the network via the data arbitration unit 206, the network interfaces 201 and 204, and the network ports 202 and 203.

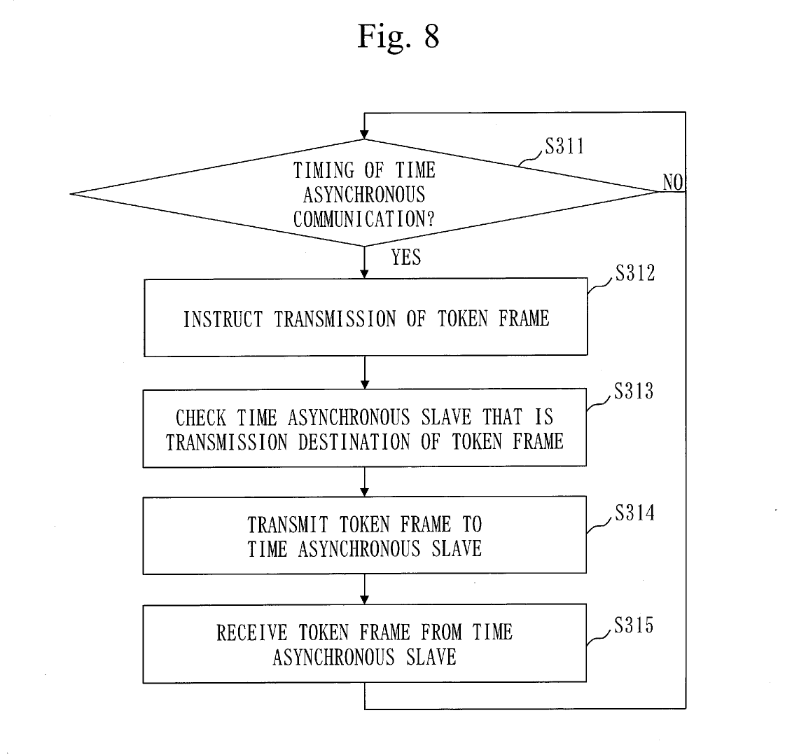

In addition, in the token management slave device TSS1, when the timer reaches the start time of the time asynchronous communication band, the time management unit 210 instructs the token management unit 212 to output the information of the token route to the communication frame generation unit 209. The token management unit 212 outputs the information of the token route to the communication frame generation unit 209. The communication frame generation unit 209 generates a token frame based on the information of the token route. The generated token frame is transmitted to the network via the data arbitration unit 206, the network interfaces 201 and 204, and the network ports 202 and 203. An example of a procedure for transmitting the token frame is illustrated in FIG. 8.

First, when the timer of the token management slave device TSS1 reaches the start time of the time asynchronous communication band (YES in step S311), in step S312, the time management unit 210 of the token management slave device TSS1 instructs the token management unit 212 to transmit the token frame. The token management unit 212 outputs the stored information of the token route to the communication frame generation unit 209 and instructs the communication frame generation unit 209 to generate the token frame.

Next, in step S313, the communication frame generation unit 209 checks the time asynchronous slave device AS that is a transmission destination of the token frame, with reference to the information of the token route output from the token management unit 212. The time asynchronous slave device AS at the first position of the toke route is the transmission destination of the token frame.

Next, in step S314, the communication frame generation unit 209 transmits the token frame to the time asynchronous slave device AS that is the transmission destination via the data arbitration unit 206, the network interface 201 or the network interface 204, and the network port 202 or the network port 203.

Next, in step S315, the time management unit 210 receives the token frame from the time asynchronous slave device AS at the last position of the token route via the network port 202 or the network port 203, the network interface 201 or the network interface 204, and the data arbitration unit 206.

The token management slave device TSS1 repeats the above procedure, and instructs the time asynchronous slave devices AS1 and AS2 to transmit data to the master device M for each of the time asynchronous communication bands, by transmitting the token frame.

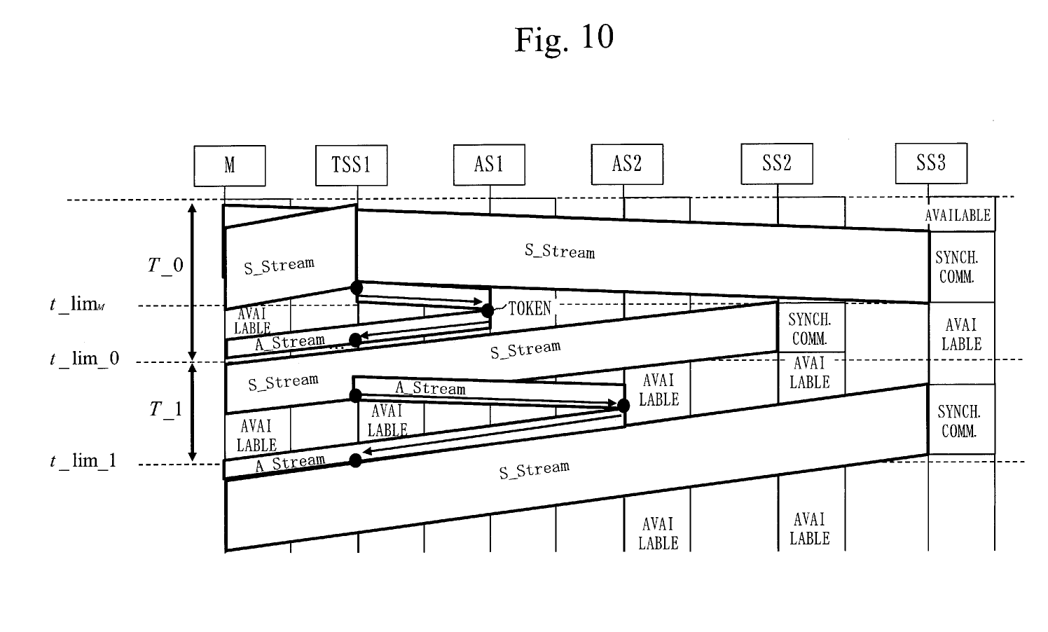

FIG. 10 illustrates an example of operation of the master device M, the token management slave device TSS1, the time synchronous slave devices SS2 and SS3, and the time asynchronous slave devices AS1 and AS2 in the fixed cycle communication phase.

The vertical axis represents time in FIG. 10. S_Stream represents a stream of the time synchronous communication and A_Stream represents a stream of the time asynchronous communication. In a configuration of FIG. 10, the token management slave device TSS1 performs token management of the time asynchronous slave device AS1 and the time asynchronous slave device AS2. After transmitting the stream of the device itself to the master device M, the token management slave device TSS1 sets an available band before relaying the next time synchronous stream (a time synchronous stream from the time synchronous slave device SS2) as a time asynchronous communication band, and transmits the token frame to the time asynchronous slave device AS1 in this time asynchronous communication band. The token frame includes a token. When receiving the token frame, the time asynchronous slave device AS1 transmits a stream of the device itself to the master device M. After transmitting the stream of the device itself, the time asynchronous slave device AS1 transmits the token frame to the token management slave device TSS1.

Next, the token management slave device TSS1 relays a stream from the time synchronous slave device SS2. After completing relaying the stream, the token management slave device TSS1 transmits the token frame to the time asynchronous slave device AS2.

When receiving the token frame, the time asynchronous slave device AS2 transmits a stream of the device itself to the master device M. After completing transmitting the stream of the device itself, the time asynchronous slave device AS2 transmits the token frame to the token management slave device TSS1.

Since the master device M computes and updates the control information of the slave devices S, the time asynchronous slave devices AS1 and AS2 transmit the frames other than token frames to the master device M. The master device M transmits the data updated in a certain cycle to the time asynchronous slave devices AS1 and AS2.

The above operation is repeated in the fixed cycle communication phase.

### Description of Effect of Embodiment

As described above, according to the present embodiment, in a network where time synchronous slave devices and time asynchronous slave devices coexist, it is not necessary to set a time slot exclusively for performing token passing for the entire network, unlike a conventional system, by performing token passing in an available band between time synchronous communication and time synchronous communication. Accordingly, a real time property can be ensured in time synchronous communication and time asynchronous communication. In addition, according to the present embodiment, communication bands can be used effectively and the communication cycle can be shortened.

### Second Embodiment

In the present embodiment, a communication system in which a plurality of token management slave devices exist will be described.

***Description of Configuration***

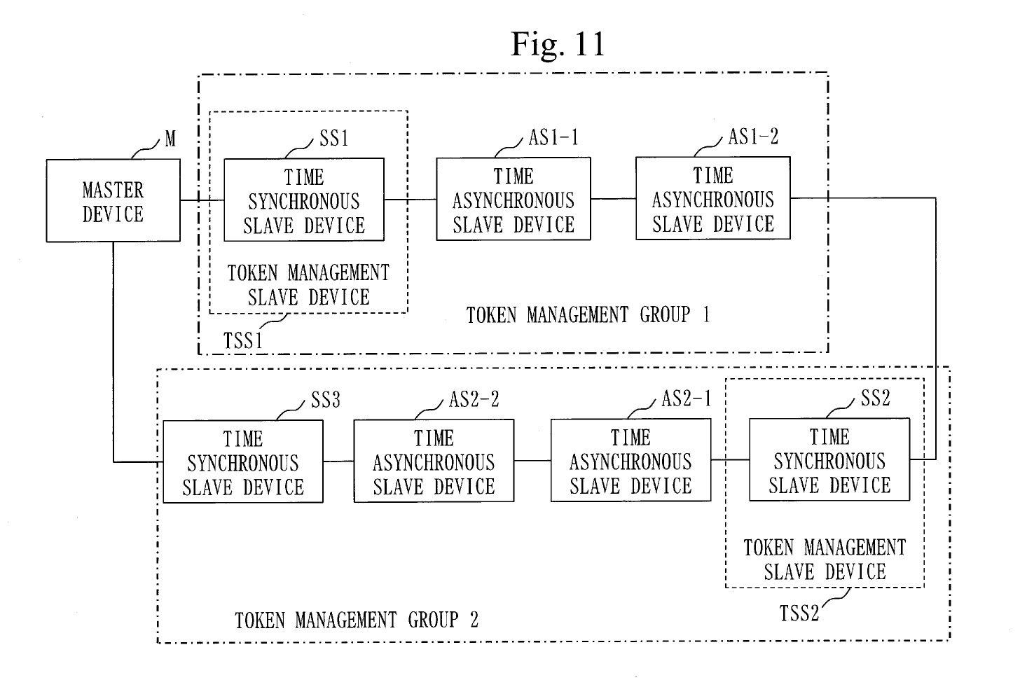

FIG. 11 illustrates an example of a configuration of a communication system according to the present embodiment.

As illustrated in FIG. 11, in the communication system according to the present embodiment, a plurality of token management slave devices exist.

In addition, in the communication system according to the present embodiment, the time synchronous slave device SS and time asynchronous slave device AS belong to any one of a plurality of token management groups. Each of the token management groups includes one token management slave device.

In an example of FIG. 11, the token management slave device TSS1, a time asynchronous slave device AS1-1, and a time asynchronous slave device AS1-2 belong to a token management group 1 and a token management slave device TSS2, a time asynchronous slave device AS2-1, a time asynchronous slave device AS2-2, and the time synchronous slave device SS3 belong to a token management group 2.

The token management slave device TSS1 and the token management slave device TSS2 are collectively referred to as a token management slave device TSS.

In addition, priorities are set for the token management groups.

In the present embodiment, it is assumed that the token management group 1 has a higher priority than that of the token management group 2.

In the present embodiment, an example of a hardware configuration of the master device M and the slave device S is the same as that illustrated in FIG. 2.

In addition, an example of a functional configuration of the communication device 02 of the master device M is the same as that illustrated in FIG. 3 and an example of a functional configuration of the communication device 02 of the slave devices S is the same as that illustrated in FIG. 4.

Hereinafter, differences from the first embodiment will be mainly described. The matters not described below are the same as those in the first embodiment.

***Description of Operation***

In the present embodiment, a start timing of token passing is scheduled between the token management slave devices TSS. That is, in the present embodiment, the start time of token passing is adjusted between the token management slave devices TSS. This processing prevents the time asynchronous slave devices AS from starting token passing at the same time. The reason for performing this processing will be described below.

If the time asynchronous slave devices AS perform token passing at the same time, each of the asynchronous slave devices AS may receive a frame from another time asynchronous slave device AS while transmitting the frame of the device itself. In this case, the time asynchronous slave device AS cannot relay the frame from the other time asynchronous slave device AS until the frame of the device itself has been transmitted and a delay occurs in relaying the frame. By an occurrence of this delay in relaying, a transmission timing of the frame by the time asynchronous slave device AS delays as compared with a transmission timing requested for the time asynchronous slave device AS by the master device M. To prevent such delay, the start time of token passing is adjusted among the token management slave devices TSS so that the time asynchronous slave devices AS do not start token passing at the same time.

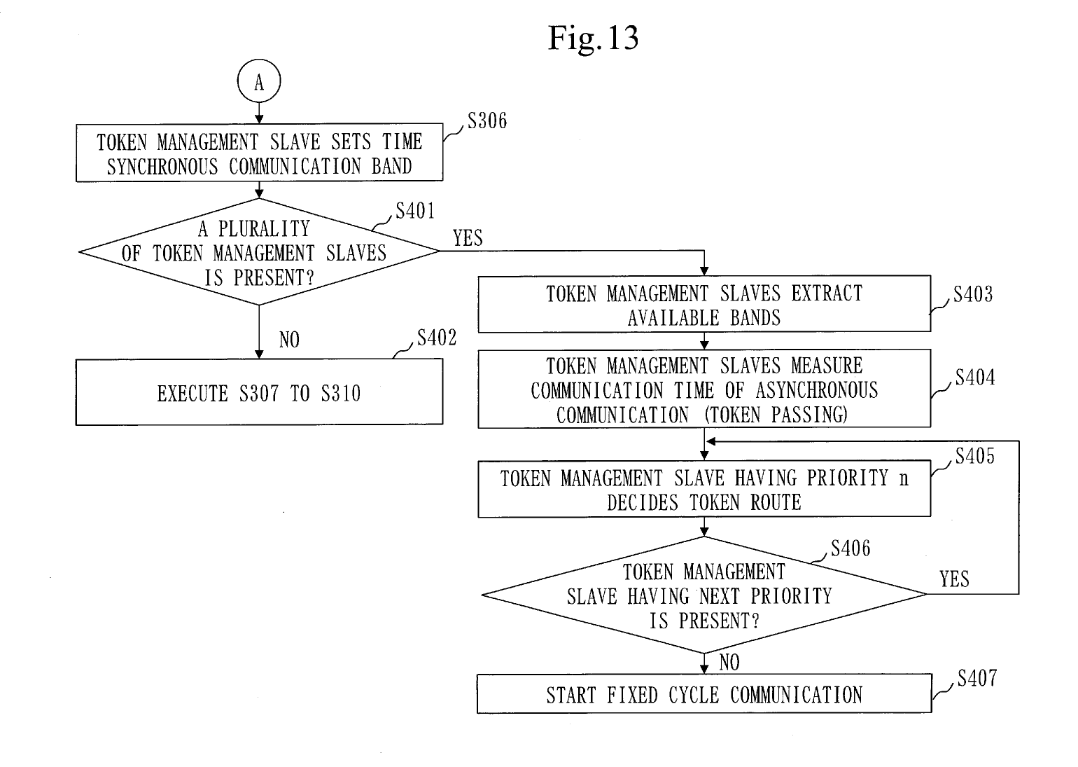

Next, an example of operation according to the present embodiment will be described with reference to the flowchart in FIG. 13.

FIG. 13 illustrates the processing after completion of S300 to S305 illustrated in FIG. 6.

Since step S306 is the same as step S306 described in the first embodiment, descriptions are omitted.

When a plurality of token management slave devices TSS is present in a communication system, the master device M reports that the plurality of token management slave devices TSS is present in the communication system, to the token management slave devices TSS. Each of the token management slave devices TSS carries out a determination of S401 after the processing of S306. When the plurality of token management slave devices TSS is present (YES in step S401), step S403 is executed. When only one token management slave device TSS is present in the communication system (NO in step S401), steps S307 to S310 described in the first embodiment are executed in step S402.

In step S403, the time management unit 210 of each of the token management slave devices TSS extracts an available band. The procedure for extracting the available band is the same as step S307 described in the first embodiment.

Next, in step S404, the time calculation unit 211 of each of the token management slave devices TSS measures the communication time of time asynchronous communication (token passing).

That is, the time calculation unit 211 of each of the token management slave devices executes the processing of step S308 described in the first embodiment and measures a time period from when the token frame is transmitted from a token management slave device TSS to when the token frame is received from a time asynchronous slave device AS belonging to the same token management group.

In an example of a configuration of FIG. 11, the time calculation unit 211 of the token management slave device TSS1 measures a time period from when the token frame is transmitted from the token management slave device TSS1 to when the token frame is received from the time asynchronous slave devices AS1-1 and AS1-2. In addition, the time calculation unit 211 of the token management slave device TSS2 measures a time period from when the token frame is transmitted from the token management slave device TSS2 to when the token frames is received from the time asynchronous slave devices AS2-1 and AS2-2. The token management slave devices TSS perform the measurement of S404 in parallel.

Next, in step S405, the time management unit 210 of the token management slave device TSS having a priority n decides the token route in a time asynchronous communication band. That is, a token route in a time asynchronous communication band is decided in descending order from a token management slave device TSS belonging to a token management group having the highest priority. The procedure for determining the token route is the same as S309 described in the first embodiment.

Since the priority of the token management group 1 is higher than that of the token management group 2 in the present embodiment, the token management slave device TS S1 first determines the token route.

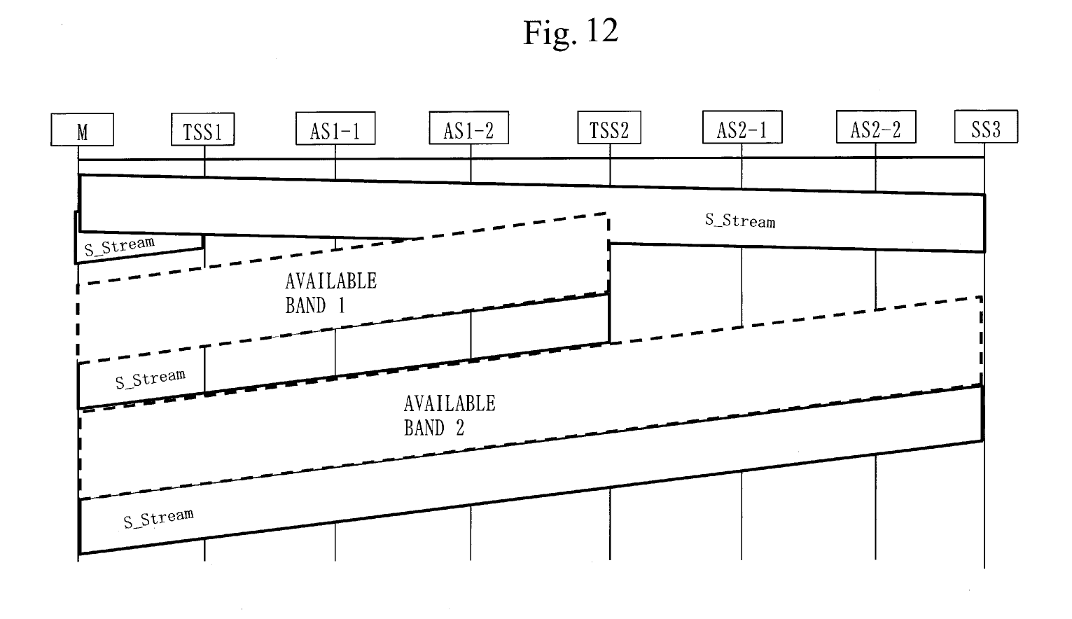

For example, in FIG. 12, the time management unit 210 of the token management slave device TSS1 sets an available band 1 as the time asynchronous communication band of the token management group 1 to which the token management slave device TSS1 belongs.

Then, the time management unit 210 of the token management slave device TSS1 determines whether the token can be circulated among the time asynchronous slave devices AS-1 and AS-2 in the available band 1 and decides the token route of the token management group 1. In a case where the token can be circulated among the time asynchronous slave devices AS-1 and AS-2 in the available band 1, the time management unit 210 decides the token route including the time asynchronous slave devices AS-1 and AS-2. In contrast, in a case where the token can be passed only to the time asynchronous slave devices AS-1 in the available band 1, the time management unit 210 decides a token route including only the time asynchronous slave device AS-1 in the available band 1. Then, the time management unit 210 decides a token route including only the time asynchronous slave device AS-2 in the available band 2. The procedure for determining the token route is the same as step S309 described in the first embodiment.

If a token management slave device TSS having the next highest priority is present (YES in step S406), the time management unit 210 of the token management slave device TSS having the next highest priority decides a token route in the token management group in step S405.

In an example of FIG. 11, the token management slave device TSS2 decides the token route. If a part of the available band 1 remains after the token management slave device TSS1 executes step S405 in an example of FIG. 12, the time management unit 210 of the token management slave device TSS1 reports the remaining band of the available band 1 to the time management unit 210 of the token management slave device TSS2. The time management unit 210 of the token management slave device TSS2 sets the remaining band of the available band 1 as a time asynchronous communication band of the token management group 2 to which the token management slave device TSS2 belongs. Then, the time management unit 210 of the token management slave device TSS2 determines whether the token can be circulated among the time asynchronous slave devices AS2-1 and AS2-2 in the remaining band of the available band 1 and decides a token route of the token management group 2.

If token routes are decided by the token management slave devices TSS of all token management groups (NO in step S406), the initial setting phase is completed and the fixed cycle communication phase is started in step S407.

Step S407 is the same as step S301 described in the first embodiment.

### Description of Effect of Embodiment

As described above, according to the present embodiment, a band occupied by time asynchronous communication can be reduced by distributing the token management slave devices and performing token passing (time asynchronous communication) at an appropriate timing by the token management slave devices. Accordingly, it is possible to prevent the communication cycle from being increased due to time asynchronous communication even in a large network in which there are many time synchronous slaves and time asynchronous slaves coexist, thereby communication of a short cycle can be obtained.

### REFERENCE SIGNS LIST

M: master device, SS1: time synchronous slave device, SS2: time synchronous slave device, SS3: time synchronous slave device, AS1: time asynchronous slave device, AS2: time asynchronous slave device, AS1-1: time asynchronous slave device, AS1-2: time asynchronous slave device, AS2-1: time asynchronous slave device, AS2-2: time asynchronous slave device, TSS1: token management slave device, TSS2: token management slave device, 01: microcomputer, 02: communication device, 03: input device, 04: input interface, 05: display interface, 06: display, 07: CPU, 08: memory, 10: transmission/reception unit, 11: management unit, 12: internal register, 101: network interface, 102: network port, 103: network port, 104: network interface, 105: buffer, 106: data arbitration unit, 107: phase management unit, 108: network configuration information management unit, 109: communication frame generation unit, 110: time management unit, 111: time calculation unit, 112: frame transfer unit, 113: frame transfer unit, 20: transmission/reception unit, 21: management unit, 22: internal register, 201: network interface, 202: network port, 203: network port, 204: network interface, 205: buffer, 206: data arbitration unit, 207: phase management unit, 208: network configuration information management unit, 209: communication frame generation unit, 210: time management unit, 211: time calculation unit, 212: token management unit, 213: frame transfer unit, 214: frame transfer unit.

1. A time synchronous slave device included in a communication system including a master device and a time asynchronous slave device communicating with the master device and not being time synchronized with the master device, the time synchronous slave device communicating with the master device and being time synchronized with the master device, the time synchronous slave device comprising:
processing circuitry to:
set an asynchronous communication period in which the maser device and the time asynchronous slave device communicate, between a plurality of synchronous communication periods that is a plurality of periods in which the master device and the time synchronous slave device communicate; and
instruct the time asynchronous slave device to communicate with the master device, when the asynchronous communication period arrives.

2. The time synchronous slave device according to claim 1,
wherein the communication system includes a plurality of synchronous slave devices,
the time synchronous slave device is selected from the plurality of time synchronous slave devices, and
the processing circuitry sets the asynchronous communication period between the plurality of synchronous communication periods in which the master device and the plurality of time synchronous slave devices communicate.

3. The time synchronous slave device according to claim 1,
wherein the processing circuitry monitors communication between the master device and the time synchronous slave device, extracts periods in which the master device and the time synchronous slave device communicate as the plurality of synchronous communication periods, and sets the asynchronous communication period between the plurality of synchronous communication periods extracted.

4. The time synchronous slave device according to claim 1,
wherein the communication system includes a plurality of time asynchronous slave devices which perform token passing,
the processing circuitry sets a plurality of the asynchronous communication periods, determines whether a token can be passed to all of the plurality of time asynchronous slave devices and all of the plurality of time asynchronous slave devices can complete communication with the master device in each of the asynchronous communication periods, and when all of the plurality of time asynchronous slave devices cannot complete communication with the master device in each of the asynchronous communication periods, selects a time asynchronous slave device which communicates with the master device from among the plurality of time asynchronous slave devices based on an order of the token passing for each of the asynchronous communication periods, and
the processing circuitry instructs the time asynchronous slave device selected to communicate with the master device, by transmitting the token, for each of the asynchronous communication periods.

5. The time synchronous slave device according to claim 4,
wherein the processing circuitry measures a time period required for all of the plurality of time asynchronous slave devices to complete communication with the master device and determines whether all of the plurality of time asynchronous slave devices can complete communication with the master device in each of the asynchronous communication periods.

6. The time synchronous slave device according to claim 1,
wherein the communication system includes a plurality of time asynchronous slave devices,
each of the time asynchronous slave devices belongs to any one of a plurality of groups,
the time synchronous slave device belongs to any one of the plurality of groups,
priorities are set for the plurality of groups, and
the processing circuitry sets the asynchronous communication period according to a priority of a belonging group to which the time synchronous slave device belongs, for a time asynchronous slave device belonging to the belonging group.

7. The time synchronous slave device according to claim 6,
wherein the processing circuitry sets the asynchronous communication period for the time asynchronous slave device belonging to the belonging group after the asynchronous communication period is set for a time asynchronous slave device belonging to a group having a higher priority than that of the belonging group.

8. A communication control method by a time synchronous slave device that is a computer included in a communication system including a master device and a time asynchronous slave device communicating with the master device and not being time synchronized with the master device, the time synchronous slave device communicating with the master device and being time synchronized with the master device, the communication control method comprising:
setting an asynchronous communication period in which the maser device and the time asynchronous slave device communicate, between a plurality of synchronous communication periods that is a plurality of periods in which the master device and the time synchronous slave device communicate; and
instructing the time asynchronous slave device to communicate with the master device, when the asynchronous communication period arrives.
